(19) United States
(12) Patent Application Publication
(10) Pub. No.: US 2006/0132848 A1
(43) Pub. Date: Jun. 22, 2006

(54) System and method for data-driven error diffusion using pointer

(75) Inventors: James R. Bailey, Shelbyville, KY (US); David A. Crutchfield, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/018,204

(22) Filed: Dec. 20, 2004

(51) Int. Cl. H04N 1/40

(52) U.S. Cl. 358/3.03

(57) ABSTRACT

Pixel data-driven error diffusion is performed by using two lookup tables. The first table receives a non-binary pixel value and outputs a selection signal in response thereto. The selection signal serves as a pointer to entries in the second table where coefficients associated with a set of error spread weights are stored. In this manner, each non-binary pixel value is mapped onto a handful of predetermined sets of error spread weights to be used in an error diffusion calculation. The first table, the second table and an associated error diffusion processor can all reside on a common integrated circuit. A third table can also be indexed at the same time to provide randomization information to be used in calculating a dynamic threshold for used in a half-toning process for the corresponding pixel.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention is directed to methods for implementing error diffusion when processing an image, such as for printing.

2. Description of the Related Art

When printing an image using an output device which places discreet units of colorants (ink drops, toner, etc.) on media, it is necessary to reduce the range of the image pixels to match the reproduction capabilities of the printing device. This typically means a reduction in the bit resolution of the image.

Most often, the reduction in bit resolution is accomplished by halftone transformation. Halftone transformation results, on a pixel-by-pixel basis for all image pixels, in the replacement of an original non-binary, or “gray-level” value of, e.g., 8 bits, with a binary value after comparison with some threshold. The threshold itself may vary dynamically depending on the non-binary pixel value, and other factors. The original 8-bit value at each pixel is thus substituted by either a “0” (representing an 8-bit value of 0) or a “1” (representing an 8-bit value of 255). The consequence of such a transformation at a pixel is that the overall “brightness” of the image is changed. To mitigate this, the change, or “error”, may be diffused to nearby, as-yet-untransformed pixels through a technique known as error diffusion. Error diffusion works by spreading the inaccuracy, or error, of the halftone decision at one pixel in the output image among nearby pixels, creating a visually superior transformation. Each original pixel value is adjusted based on the error contributed by adjacent and nearby pixels, and these contributions are taken into account in calculating the correct transformed value for the pixel.

There are a number of error diffusion techniques, each of which uses a different combination of thresholding approaches, collection of nearby pixels to which the error is spread, error weightings to each of these nearby pixels, and other factors. The Floyd-Steinberg algorithm, developed in 1975 and known to those skilled in the art, is one of the more well-known implementations of error diffusion. This algorithm generates a series of error values for each image element as an image line is transformed. These error values are calculated by taking a fraction of nearby pixel error values and adding them together to represent a pixel location.

In the Floyd-Steinberg algorithm, the error from a transformed pixel 120 is spread to a collection of four specific nearby pixels in the fashion shown in FIG. 1A. More particularly, the error from transformed pixel 120 is spread to pixels 122, 124, 126 and 128 using error spread weights 7/16, 1/16, 5/16 and 3/16, respectively, the error spread weights representing the proportion of error at transformed pixel 120 that is spread to each untransformed, error-receiving pixel. FIG. 1B shows that an untransformed pixel 150 that is about to be transformed using Floyd-Steinberg error diffusion, receives a portion of the error from each of four nearby, previously transformed pixels 152, 154, 156 and 158, using error spread weights of 7/16, 1/16, 5/16 and 3/16, respectively.

From the foregoing description, it can be seen that in the Floyd-Steinberg algorithm the error created from transforming a pixel is spread to four adjacent pixels. Furthermore, prior to transformation, each pixel receives a portion of the error from each of the four adjacent pixels that have previously been transformed.

While specific error spread weights of 7/16, 1/16, 5/16 and 3/16 are discussed above, it should be understood that other sets of error spread weights, whose members add up to 1.0, may be used instead. In the general case, moving clockwise from transformed pixel (i, j) in an image, one can consider the set of four error spread weights to be Wᵢⱼ={w1, w2, w3, w4}. Thus, in FIG. 1a, w1=7/16; w2=1/16; w3=5/16 and w4=3/16.

FIG. 2 shows a prior art system 200 that uses the gray-level value of the pixel being transformed to select from among a predetermined set of error spread weights.

The system 200 includes a general purpose microprocessor 202 that is connected to a main memory 204. Main memory 204 typically stores the input pixel data of an image whose pixels are to be transformed from a non-binary format to a binary format, using error diffusion. The microprocessor 202 is part of an Application Specific Integrated Circuit (ASIC) 210 (represented by the dotted box) configured to implement error diffusion. The dashed arrows represent connections between the microprocessor 202 and the other components of the ASIC, through data buses, control buses and other structures known to those skilled in the art of integrated circuit design. While in this prior art embodiment, the error diffusion preferably is performed using hardware on the ASIC, it can instead be performed entirely in software by the microprocessor 202. It is further understood that in some embodiments, the main memory 204 can also be part of the ASIC 210, or the input pixel data may be stored in a local memory on-board the ASIC.

In addition to the microprocessor 202, the prior art ASIC 210 includes an error diffusion processor 212, threshold generation circuitry 214, an error buffer 216, and a lookup table (LUT) 218. It is understood that in some prior art embodiments, lookup table 218 may be in main memory 204 instead of on-board the ASIC.

The threshold generation circuitry 214 creates a threshold 238 that is used to compare with each modified non-binary (e.g., 8-bit) gray level pixel datum to determine whether the corresponding pixel is to be set to “0” or “1”. The threshold generation circuitry 214 is under the control of the microprocessor 202 and can include pseudo-random circuitry or the like to form a dynamic threshold.

As is known to those skilled in the art, the error diffusion processor 212 typically processes image pixel data in line-order—each pixel belonging to one line of an image is error diffused, before pixels of the next line are processed. As the errors for the transformed pixels in one line are calculated, the partial errors to be received by each pixel in the next line are accumulated and stored in the error buffer 216. The “previous line error data” 240 is used by the error diffusion processor 212 when processing a current line of image data.

The 8-bit pixel data 244 is also input to 256×16 bit lookup table 218. Thus, the lookup table stores one 16-bit word, comprising an error spread vector, for each of the 256 possible 8-bit gray level values (0-255), which are used to index the appropriate entry in the lookup table 218. In response to a particular 8-bit pixel value input thereto, the lookup table 218 outputs a data signal 250 comprising a 16-bit word. Since one 16-bit word is stored for each of the 256 possible 8-bit pixel values, the lookup table 218 has an overall size of 4096 bits.

This 16-bit error spread vector 250 comprises error spread information that is used by the error diffusion processor 212 to allocate the error from half-toning that particular pixel. In a preferred embodiment, this error spread information comprises four 4-bit error spread coefficients. For this, the 16-bit error spread vector 250 can be considered as four 4-bit numbers ranging from 0-15, each number corresponding to the relative weight one of the four error spread weights discussed above. Thus, as seen in FIG. 2A, the first four bits (bits 15-12) of the 16-bit error spread vector 250 correspond to weight w1=7, the next four bits (bits 11-8) correspond to w2=1, the next four bits (bits 7-4) correspond to w3=5; and the last four bits (bits 3-0) correspond to w4=3.

The error diffusion processor 212 uses each 4-bit value as a relative weighting, and so multiplies the total error by each of the 4 bit values to create four partial errors that are used within the error diffusion processor, in a known manner. When the 16-bit error spread vector 250 is provided by the lookup table 218 to the error diffusion processor 212, the latter understands the meaning of the four groupings of bits and uses them accordingly in the error diffusion algorithm.

The pixel data 244 from main memory 204, the threshold 238 provided by the threshold block 214, the previous line error data 240 from the error buffer 216, and the error spread coefficients 250 from the lookup table 218 are all used by the error diffusion processor 212. Once the error diffusion is performed, the error diffusion processor 212 then sends the half-toned error-diffused pixel data 260 to the main memory 204 where the data comprising the halftone image is stored.

It the above discussion, the relative weights in the 16-bit error spread vector 250 each can take on one of N1=16 values (ranging from 0-15), and so require only four bits each. This allows for the relative weights to have a resolution of 1/16. However, in the general case, higher resolutions may be provided, N1=32, N1=64, etc. For hardware-based implementations, such as in an ASIC, it is most convenient for N1 to be a power of 2. Thus, in FIGS. 2 & 2A, if a 1/32 resolution is desired, then N1=32 and a total of n=5=log₂ 32 bits are needed for each coefficient. In such case, the lookup table 218 will be of size 256 by 20 bits, the 20 bits comprising four 5-bit coefficients, each of which may range from 0-31.

Also, in the above discussion, it is assumed that the input pixel data has m=8 bits, which therefore required 2⁸=256 entries in the lookup table 218. It is understood, however, that the pixel data may comprise some other number of bits. For example, if m=12 bits, then the lookup table would have a total of 2¹²=2048 entries.

Finally, in the above discussion, using the Floyd-Steinberg error diffusion algorithm, the error from a transformed pixel is spread to a total of k=4 nearby pixels. Using other error diffusion algorithms, the error may be spread to some other number of pixels. Thus, if the error were spread to a total of k=8 nearby pixels, then a set of eight coefficients corresponding to the weight set {w1, w2, . . . , w8} would have to be provided by the lookup table 218 in response to being indexed by a single pixel value. In such case, the look-up table 218 would have to be of size 256 by 32, assuming m=8 bit pixel values and n=4 bit coefficients.

From the foregoing, it can be seen that in the general case, the lookup table 218 is of size 2^{m} by (n*k) bits, where m, n and k have the values described above.

### SUMMARY OF THE INVENTION

In one aspect, the present invention is directed to a system, such as a printer, that is configured to perform error diffusion on image data pixels, each image data pixel comprising a non-binary pixel value. A system in accordance with the present invention can comprise a first table indexed by a non-binary pixel value of a data pixel, and configured to output a first selection signal in response thereto; a second table indexed by said selection signal, and configured to output a first data signal in response thereto, the first data signal comprising error spread information; and an error diffusion processor configured to receive and utilize the first data signal in performing error diffusion for that data pixel.

In another aspect, the present invention is directed to an integrated circuit configured to perform error diffusion on image data pixels, each image data pixel comprising a non-binary pixel value. An integrated circuit in accordance with the present invention can comprise a first table indexed by a non-binary pixel value of a data pixel, and configured to output a first selection signal in response thereto; a second table indexed by said selection signal, and configured to output a first data signal in response thereto, the first data signal comprising error spread information; and an error diffusion processor configured to receive and utilize the first data signal in performing error diffusion for that data pixel.

In yet another aspect, the present invention is directed to a method of performing error diffusion on image data pixels in which method each image data pixel comprises a non-binary pixel value used to select error spread weights. The method comprises indexing a first table with a non-binary pixel value of a data pixel to thereby output a first selection signal; indexing a second table with said first selection signal to output a first data signal, the first data signal comprising error spread information; and calculating error spread values based on the error spread information.

### BRIEF DESCRIPTION OF THE DRAWINGS

The invention is now described with reference to the attached drawings in which:

FIG. 1A illustrates the prior art principle of error spread weights applied to the error of a transformed pixel;

FIG. 1B illustrates the prior art principle of error spread weights received by a pixel to be transformed;

FIG. 2 presents a prior art block diagram of an error diffusion implementation in which pixel data is directly used to index error spread coefficients;

FIG. 2A shows the contents of an entry in the lookup table in FIG. 2; and

FIG. 3 shows a block diagram of an error diffusion implementation in accordance with an embodiment of the present invention.

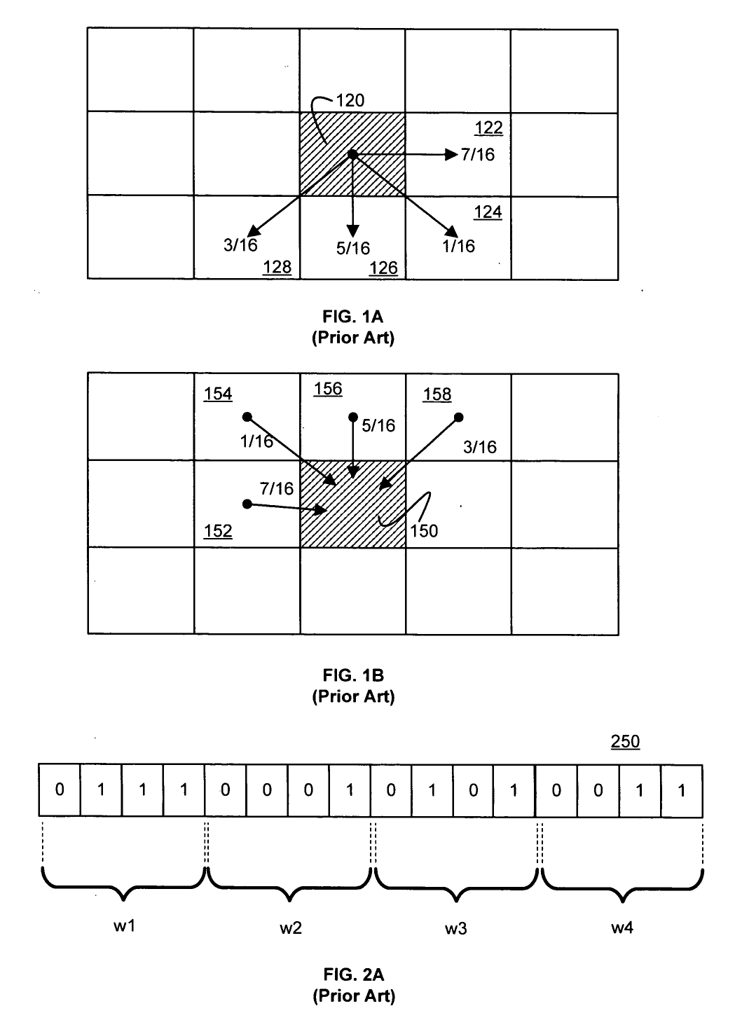

### DETAILED DESCRIPTION

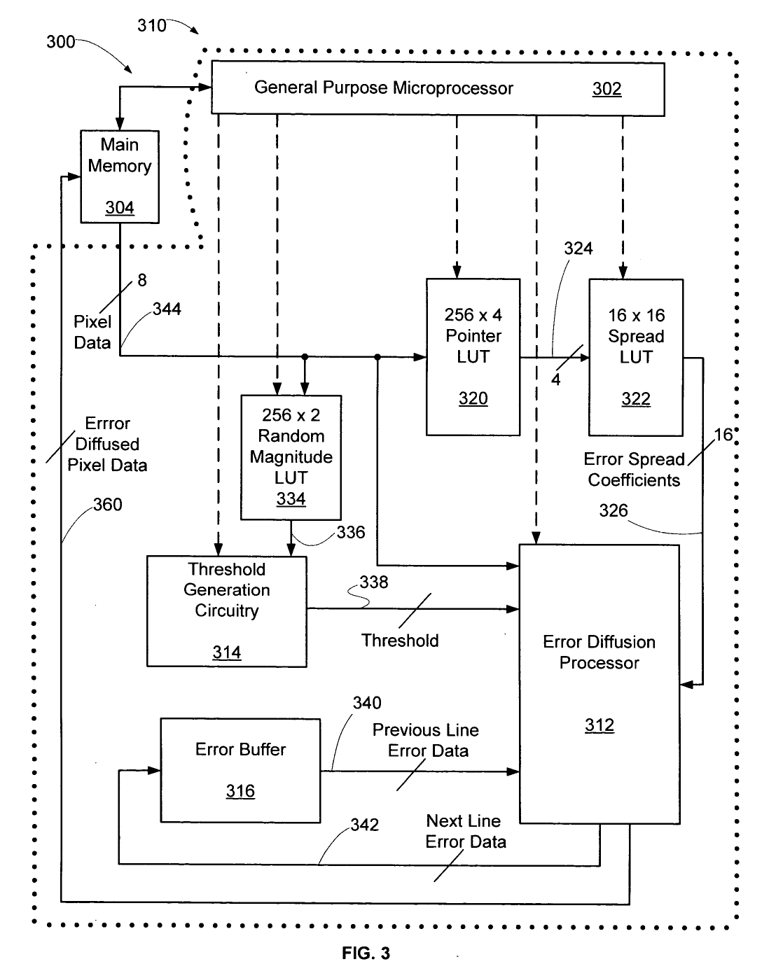

FIG. 3 shows a block diagram of a 300 that implements error diffusion in accordance with an embodiment of the present invention. The system 300 can belong to a printer or a multifunction device that receives an image with multi-bit data pixels and outputs halftone images while using an error diffusion algorithm. In a particularly preferred environment, the system is part of a stand-alone printer or multifunction device of the sort capable of printing photographs directly from a digital camera without first having to download the photographs to a personal computer.

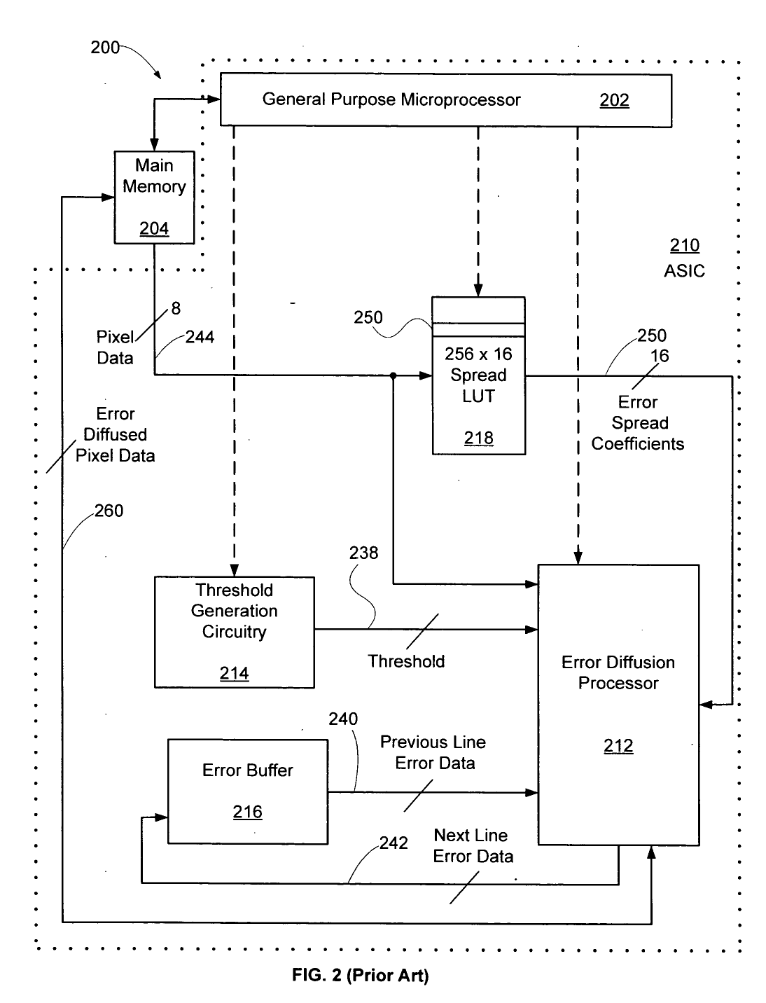

The system 300 includes an ASIC 310 (represent by the dotted line) having an associated microprocessor 302, and a main memory 304. The ASIC 310 also includes an error diffusion processor 312, threshold generation logic 314 and an error buffer 316, much like in the prior art ASIC described with reference to FIG. 2. It is understood that while the image data preferably is stored in main memory 304, it may instead be stored in a local memory on-board the ASIC 310.

The ASIC 310 uses a pair of lookup tables 320, 322 to provide the error spread coefficients. The microprocessor 302 is capable of sending data to the lookup tables 320, 322, and so may be able to load these tables from time to time under software control. While in a preferred embodiment the lookup tables 320, 322 are on-board the ASIC, and most preferably formed as a dedicated SRAM, the present invention also contemplates that they can instead reside in main memory 304.

The first lookup table 320 preferably is of size 256 by 4 bits. In the general case, one may consider the first lookup table to be of size 2^{m} by j bits, with 2^{j} being the maximum number of unique error spread vectors in the second lookup table 322. In this case, m=8 is the number of bits of the non-binary pixel value, while j=4 is the number of bits needed by the first selection signal 324 (described below) to select from among 2^{j} error spread vectors.

In the general case, the second lookup table may be considered to be of size 2^{j} by (n*k) where n is the number of bits needed for the required resolution of the error spread coefficients and k is the number of nearby pixels to which error is spread, much as discussed with respect to FIG. 2. The second lookup table 322 preferably is of size 16 by 16 bits (i.e., 2^{j=4} by n=4*k=4).

The first lookup table 320 is controlled by the microprocessor 302 which can, among other things, load values into it. In a preferred embodiment, the first lookup table 320 receives an 8-bit pixel value 344, and outputs a first selection signal 324 comprising j=4 bits, representing values of 0-15. This first selection signal 324 of 4 bits is used as a pointer to the second lookup table 322. In response to the first selection signal 324, the second lookup table 322 outputs a first data signal 326. This first data signal 326 is a 16-bit error spread vector comprising error spread information. The 16-bit error spread information is in the form of four 4-bit error spread coefficients which are used by the error diffusion processor 312, much as discussed above with respect to FIG. 2.

The system 300 of the present invention uses the two lookup tables 320, 322 in tandem to achieve savings in overall size. Their respective sizes of 256×4 bits and 16×16 bits result in an overall size of 1280 bits, which is roughly 69% fewer bits than the 4096 bits used for the 256×16 bit lookup table 218 in FIG. 2. This can result in savings in both space and cost for an ASIC.

This implementation also means that all of the 256 pixel values must be mapped onto no more than sixteen 16-bit error spread vectors. In other words, unlike the system 200 of FIG. 2 where each of the 256 possible 8-bit pixel values maps onto its own error spread vector 250, the present system 300 requires that different 8-bit pixel values share the same error spread vector. Which 8-bit pixel values share which error spread vector is empirically determined and this is mapped into non-volatile memory or, if implemented in software, as a constant declaration.

In another aspect of an embodiment of the present invention, a third lookup table 334 is provided. Like the first lookup table 320, the third lookup table 334 is also controlled by the microprocessor 302 which can, among other things, load values into it. Like the first lookup table 320, the third lookup table 334 is also indexed by the non-binary pixel values 344. Thus, the third lookup table 334 has 2^{m} entries, where m is the number of bits used to represent a pixel value.

In response to a particular pixel value, the third lookup table 240 outputs a second data signal 336. This second data signal 336 comprises randomizing information that is used by the threshold generation circuitry 314. In a preferred embodiment, the second data signal comprises r=2 bits, and so the third table 334 is of size 256 by 2.

It should be noted here that while first lookup table 320 and third lookup table 334 are depicted as separate blocks in FIG. 3, it is understood that, when implemented on a common integrated circuit, they can be formed as a single contiguous portion of the integrated circuit of size 256 by 6 bits, or in the general case, 2^{m} by (j+r) bits.

The threshold generation circuitry 314 is configured to receive and utilize this second data signal 336 in creating a dynamic threshold 338 for presentation to the error diffusion processor 314. As discussed further below, in one embodiment, the second data signal 336 is used to designate the number of bits (0-3) by which an internal value of the threshold generation circuitry 314 is shifted left (effectively, hardware multiplied by 1, 2, 4 or 8, respectively), thereby imparting some pixel-value-driven randomness in the creation of a dynamic threshold by selectively amplifying this internal value.

In a preferred embodiment, the threshold generation circuitry 314 comprises a 16-bit linear feedback shift register (LFSR) that is used to pseudo-randomly alter the threshold 338, in conjunction with the second data signal, as discussed next. The threshold generation circuitry 314 has a base threshold T (e.g., T=2048), which can be internally hardwired, provided by the microprocessor 302, or obtained from some other means. A value V represents the b least significant bits of the 16-bit LFSR, b being no more than some microprocessor-determined maximum number which, in one embodiment is b=9. Since V is based on no more than the b=9 least significant digits, in this embodiment, V is between +511 to −512. This value V is then amplified within the threshold generation circuitry 314 by a factor of 1, 2, 4 or 8, depending on the value represented by the two bits of the second data signal 336, to form an amplified value V′. In a preferred embodiment, the dynamic threshold 338 provided to the error diffusion processor 312 is the sum of the base threshold T and this amplified value V′, or dynamic threshold T′=T+V′. This dynamic threshold is then compared against a modified pixel value in a half-toning process which results in the formation of a binary image data pixel. The modified pixel value itself is formed in the error diffusion processor 312 from the original pixel value and accumulated error values, in a manner known to those skilled in the art. This binary image data pixel is then stored in main memory 304 or, when provided for, a local memory on-board the ASIC 310.

The present invention has been described with respect to specific embodiments. However, it will be appreciated that modifications and variations of the present invention are covered by the above teachings and within the purview of the appended claims without departing from the spirit and intended scope of the invention.

What is claimed is:

1. A system configured to perform error diffusion on image data pixels, each image data pixel comprising a non-binary pixel value, the system comprising:
a first table indexed by a non-binary pixel value of a data pixel, and configured to output a first selection signal in response thereto;
a second table indexed by said first selection signal, and configured to output a first data signal in response thereto, the first data signal comprising error spread information; and
an error diffusion processor configured to receive and utilize said first data signal in performing error diffusion for said data pixel.

2. The system according to claim 1, wherein:
the image data pixels have m bit values;
the first table is of size 2^{m} by j bits; and
the second table is of size 2^{j} by (n*k) bits,
wherein:
j, k, m and n are integers;
2^{j} is the number of different possible types of error spread information;
k is the number of nearby pixels to which error is spread during error diffusion; and
n is the number of bits used to express the error spread information for each of the k nearby pixels.

3. The system according to claim 2, wherein:
m is 8, j is 4, n is 4 and k is 4.

4. The system according to claim 1, wherein first data signal comprises a plurality of coefficients, each coefficient associated with one error spread weight for use in an error diffusion algorithm implemented by the error diffusion processor.

5. The system according to claim 1, wherein the first table, the second table and the error diffusion processor are all resident on a single integrated circuit.

6. The system according to claim 5, further comprising a microprocessor also resident on the single integrated circuit, the microprocessor being capable of sending data to the first table and the second table.

7. The system according to claim 1, further comprising:
a third table also indexed by said non-binary pixel value of said data pixel, and configured to output a second data signal in response thereto, the second data signal comprising randomizing information; and
threshold generation circuitry configured to receive and utilize said second data signal to create a dynamic threshold for presentation to said error diffusion processor.

8. The system according to claim 7, wherein:
the image data pixels have m bit values;
the first table is of size 2^{m} by j bits;
the second table is of size 2^{j} by (n*k) bits; and
the third table is of size 2^{j} by r bits,
wherein:
j, k, m, n and r are integers;
2^{j} is the number of different possible types of error spread information;
k is the number of nearby pixels to which error is spread during error diffusion;
n is the number of bits used to express the error spread information for each of the k nearby pixels; and
r is the number of bits used to express the randomizing information.

9. The system according to claim 8, wherein:
m is 8, j is 4, n is 4 and k is 4 and r is 2.

10. The system according to claim 7, wherein the first table, the second table, the third table and the error diffusion processor are all resident on a single integrated circuit.

11. The system according to claim 10, wherein the first table and the third table form a single contiguous portion of said integrated circuit.

12. An integrated circuit configured to receive image data pixels comprising non-binary pixel values, perform error diffusion on the received image data pixels, and output binary image data pixels, the integrated circuit comprising:
a first table indexed by a non-binary pixel value of a data pixel, and configured to output a first selection signal in response thereto;
a second table indexed by said first selection signal, and configured to output a first data signal in response thereto, the first data signal comprising error spread information; and
an error diffusion processor configured to receive and utilize said first data signal in performing error diffusion for said data pixel.

13. The integrated circuit according to claim 12, wherein:
the image data pixels have m bit values;
the first table is of size 2^{m} by j bits; and
the second table is of size 2^{j} by (n*k) bits,
wherein:
j, k, m and n are integers;
2^{j} is the number of different possible types of error spread information;
k is the number of nearby pixels to which error is spread during error diffusion; and
n is the number of bits used to express the error spread information for each of the k nearby pixels.

14. The integrated circuit according to claim 13, wherein:
m is 8, j is 4, n is 4 and k is 4.

15. The integrated circuit according to claim 12, wherein first data signal comprises a plurality of coefficients, each coefficient associated with one error spread weight for use in an error diffusion algorithm implemented by the error diffusion processor.

16. The integrated circuit according to claim 12, further comprising:
a third table also indexed by said non-binary pixel value of said data pixel, and configured to output a second data signal in response thereto, the second data signal comprising randomizing information; and
threshold generation circuitry configured to receive and utilize said second data signal to create a dynamic threshold for presentation to said error diffusion processor.

17. The integrated circuit according to claim 16, wherein the first table and the third table form a single contiguous portion of said integrated circuit.

18. The system according to claim 16, wherein:
the image data pixels have m bit values;
the first table is of size 2^{m} by j bits;
the second table is of size 2^{j} by (n*k) bits; and
the third table is of size 2^{j} by r bits,
wherein:
j, k, m, n and r are integers;
2^{j} is the number of different possible types of error spread information;
k is the number of nearby pixels to which error is spread during error diffusion;
n is the number of bits used to express the error spread information for each of the k nearby pixels; and
r is the number of bits used to express the randomizing information.

19. A method of performing error diffusion on image data pixels, each image data pixel comprising a non-binary pixel value used to select error spread weights, the method comprising:
indexing a first table with a non-binary pixel value of a data pixel to thereby output a first selection signal;
indexing a second table with said first selection signal to output a first data signal, the first data signal comprising error spread information; and
calculating error spread values based on the error spread information.

20. The method according to claim 19, further comprising:
indexing a third table with said non-binary pixel value of a data pixel to thereby output a second data signal in response thereto, the second data signal comprising randomizing information;
creating a dynamic threshold using, at least in part, said data signal; and
comparing the dynamic threshold with a modified-pixel value in a half-toning process.
